(19) United States
(12) Patent Application Publication
(10) Pub. No.: US 2026/0181288 A1
(43) Pub. Date: Jun. 25, 2026

(54) BITLINE CLAMPING CIRCUITS FOR BITLINE-CUT IMAGE SENSORS

(71) Applicant: OMNIVISION TECHNOLOGIES, INC., Santa Clara, CA (US)

(72) Inventors: Lei Zou, Oslo (NO); Sindre Mikkelsen, Ski (NO); Tomas Geurts, Parkstraat (BE)

(21) Appl. No.: 18/988,704

(22) Filed: Dec. 19, 2024

(51) Int. Cl. H04N 25/78; H04N 25/709; H04N 25/77

(52) U.S. Cl. CPC H04N 25/78; H04N 25/709; H04N 25/77

(57) ABSTRACT

Bitline cut image sensors with ASIC clamping are disclosed. In some embodiments, an imaging system includes a pixel array and a replica voltage reference generation circuit. The pixel array can include a plurality of pixel circuits, select ones of the pixel circuits each including a row select transistor and a source follower transistor coupled between a supply voltage and the row select transistor. The replica voltage reference generation circuit can have an input coupled to the row select transistor. The replica voltage reference generation circuit can be configured to receive a voltage at the input and generate a clamp voltage that follows the voltage received at the input for each of one or more bitlines coupled to one or more outputs of the replica voltage reference generation circuit.

### TECHNICAL FIELD

This disclosure relates generally to image sensors. For example, several embodiments of the present disclosure relate generally to bitline-cut complementary metal oxide semiconductor (CMOS) image sensors with application-specific integrated circuit (ASIC) clamping circuits, and to associated systems, devices, and methods.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

A typical image sensor operates in response to image light from an external scene being incident upon the image sensor. The image sensor includes an array of pixels having photosensitive elements (e.g., photodiodes) that absorb a portion of the incident image light and generate image charge upon absorption of the image light. The image charge photogenerated by the pixels may be measured as analog output image signals on column bitlines that vary as a function of the incident image light. In other words, the amount of image charge generated is proportional to the intensity of the image light, which is read out as analog image signals from the column bitlines and converted to digital values to provide information that is representative of the external scene.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 is a partially schematic diagram of an imaging system configured in accordance with various embodiments of the present technology.

FIG. 2 is a partially schematic diagram of a clamping circuit configured in accordance with various embodiments of the present technology.

FIG. 3 is a partially schematic diagram of another clamping circuit configured in accordance with various embodiments of the present technology.

FIG. 4 is a partially schematic diagram of still another clamping circuit configured in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

The present disclosure relates to bitline-cut image sensors with application-specific integrated circuit (ASIC) clamping circuits, and to associated systems, devices, and methods. For example, several embodiments of the present technology are directed to various bitline-cut image sensors that can be operated to provide improved image quality and reduced noise. Such image sensors can include ASIC clamping circuits usable to provide substantially a same clamp level as other types of clamping circuits implemented in the image sensors, such as rolling clamp circuits. In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments.

It is appreciated that the term “photosensor” or “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. Overview

Bitline-cut image sensors with ASIC clamping circuits (and associated systems, devices, and methods) are disclosed herein. For example, several embodiments of the present technology are directed to various bitline-cut image sensors that can be operated to provide improved image quality and reduced noise.

A bitline-cut image sensor is a type of image sensor that includes multiple bitlines per column of a pixel array. More specifically, instead of having a single bitline coupled to all pixels of a given column of a pixel array, a bitline-cut image sensor can include two or more bitlines coupled to the pixels of the given column. For example, a first half of the pixels in the column can be coupled to a first or “top” bitline, and a second half of the pixels in the same column can be coupled to a second or “bottom” bitline. Thus, in this example, instead of using a single bitline for all pixels of the column, the single bitline is “cut” into two separate bitlines: the first/top bitline and the second/bottom bitline. A region along the pixel array at which adjacent memory rows are coupled to different bitlines (e.g., the region at which (i) a first memory row is coupled to the first/top bitline and (ii) a second (e.g., immediately adjacent) memory row is coupled to a second/bottom bitline) is referred to herein as a “bitline cut region.”

In many image sensors, presence of noise and pulse feedthrough (e.g., small, unwanted fluctuations or interference signals) and high resistance-capacitance (RC) loads on bitlines can significantly affect performance of the image sensors. For example, state changes can be delayed as a result. One solution is to clamp bitline voltages to a predetermined voltage range, thereby preventing excessive voltage swings, reducing settling times, and reducing fixed pattern noise (FPN). Certain forms of clamping (e.g., rolling clamping), however, rely on leveraging pixels in an adjacent row that are coupled to a same bitline. Thus, in a bitline-cut image sensor, pixels of a memory row positioned near the bitline cut region may not have pixels in an adjacent row that are coupled to a same bitline and that can be leveraged to perform these forms of clamping. As such, many bitline-cut image sensors instead employ an ASIC clamping circuit to clamp bitline voltages for pixels of memory rows positioned proximate the bitline cut region.

Use of an ASIC clamping circuit, however, is not without its own problems. For example, although employing an ASIC clamping circuit can address issues associated with certain pixels lacking adjacent pixels coupled to a same bitline (e.g., for performing rolling clamping), use of an ASIC clamping circuit can introduce a new clamping voltage level that is different from the clamping voltage level used for the other pixels of a pixel array (e.g., during rolling clamping). In some cases, the difference between the ASIC clamping voltage level used for pixels proximate the bitline cut region and the clamping voltage level used for the other pixels of the array (e.g., as part of rolling clamping) can be attributable to process differences. For example, in embodiments that utilize row select (RS) transistors of (e.g., spare) pixels of adjacent pixel rows to perform rolling clamping, the difference between the ASIC clamping voltage level used for pixels proximate the bitline cut region and the clamping voltage level used for the other pixels of the array can be attributed at least in part to the transistors of the ASIC clamping circuit having different threshold voltages from threshold voltages of the row select transistors. Temperature drift and/or temperature differences between the ASIC clamping circuit and the rolling clamping circuits can also exacerbate the difference between the threshold voltages, such as by inducing drift of one or more of these threshold voltages. As a result, a bitline clamping reference signal applied to a gate of a row select transistor will cause the row select transistor to produce a different clamping voltage than that produced by applying the same bitline clamping reference signal to a gate of a transistor of the ASIC clamping circuit. For a same light source, differences between the ASIC clamping voltage level used for pixels proximate the bitline cut region and the clamping voltage level used for the other pixels of the array can lead to image quality problems, such as visible image banding due to different bitline voltage swings. As such, a same bitline clamping reference signal applied to a gate of a row select transistor of a pixel to produce a bitline clamping voltage cannot also be directly provided to gates of transistors of an ASIC clamping circuit, as doing so is likely to produce different bitline clamping voltages and may result in visible image banding.

It is appreciated that clamping circuit designs configured in accordance with various embodiments of the present technology address at least some of the issues discussed above. For example, a clamping circuit (also referred to herein as an “ASIC clamping circuit”) disclosed herein can generate and provide a clamping level (also referred to herein as an “ASIC bitline clamping voltage”) to bitlines coupled to a subset of pixels in a pixel array (e.g., pixels proximate a bitline cut region of a bitline-cut image sensor). The clamping level provided by the clamping circuit can be substantially the same as a clamping level provided (e.g., by rolling clamping circuits) to bitlines coupled to other pixels in the pixel array. In some embodiments, clamping circuits of the present technology can include one or more op-amps, one or more transistors, and/or other circuit components that can be used to follow a clamping voltage level (e.g., a “rolling clamp voltage level”) at the pixel array. More specifically, the circuit components of the clamping circuits can be arranged such that clamping voltage levels at bitlines coupled to the clamping circuits ultimately follow corresponding clamping voltage levels provided at the pixel array.

Thus, as will be shown and described in the various examples below, an imaging system can include (a) a pixel array including a plurality of pixel circuits and (b) a clamping circuit including an input stage coupled to the pixel array and an output stage coupled between the input stage and one or more bitlines. Select ones of the pixel circuits can include (i) a row select transistor and (ii) a source follower transistor coupled between a first supply and the row select transistor. The input stage can include (i) an op-amp having a non-inverting input coupled to the row select transistor, an inverting input, and an output, and (ii) a first transistor having a gate coupled to the output of the op-amp, a drain coupled to a second supply voltage, and a source coupled to the inverting input of the op-amp. The output stage can include one or more second transistors, each having a gate coupled to the output of the op-amp, a drain coupled to the second supply voltage, and a source coupled to a corresponding one of the one or more bitlines.

In some embodiments, an imaging system can include (a) a pixel array including a plurality of pixel circuits and (b) a clamping circuit including an input stage coupled to the pixel array and an output stage coupled between the input stage and one or more bitlines. Select ones of the pixel circuits can include (i) a row select transistor and (ii) a source follower transistor coupled between a first supply and the row select transistor. The input stage can include a first transistor having a drain coupled to a second supply voltage, a source coupled to the row select transistor, and a gate coupled to the drain of the first transistor. The output stage can include one or more second transistors, each having a gate coupled to the gate of the first transistor, a drain coupled to the second supply voltage, and a source coupled to a corresponding one of the one or more bitlines.

The present technology is expected to offer several advantages. For example, several clamping circuits (e.g., ASIC clamping circuits) of the present technology utilize a feedback loop that is expected to compensate for threshold voltage mismatches between transistors of different clamping circuits (e.g., an ASIC clamping circuit and a rolling clamping circuit) due to process differences and/or threshold voltage drift due to temperature drift. Additionally, or alternatively, several embodiments of the present technology utilize multiple row select transistors from different locations of idle pixel rows to provide a rolling clamp voltage, which is expected to average out pixel-to-pixel threshold voltage offsets. In these and other embodiments, various clamping voltage reference signals (each one unique to a readout mode of the image sensor) can be used to control clamping circuits of the present technology such that bitline clamping voltages provided by the clamping circuits match readout modes (e.g., high conversion gain, low conversion gain, lateral overflow integration capacitor (LOFIC)) of the image sensor, which is expected to reduce, minimize, or eliminate negative effects associated with temperature-induced threshold voltage drift of row select transistors. In other words, clamping circuits configured in accordance with various embodiments of the present technology are expected to provide bitline clamping voltage levels that are substantially equal to corresponding clamping voltage levels provided (e.g., by rolling clamping circuits) at the pixel array. As such, the present technology is expected to prevent (or at least substantially reduce) visible image banding notwithstanding the use of both rolling clamping and ASIC clamping for the same pixel array. By providing a uniform clamping voltage level for all pixels in a pixel array, the present technology is also expected to reduce noise and improve overall image quality.

### B. Select Embodiments of Imaging Sensors With Clamping Circuits, and Associated Systems, Devices, and Methods

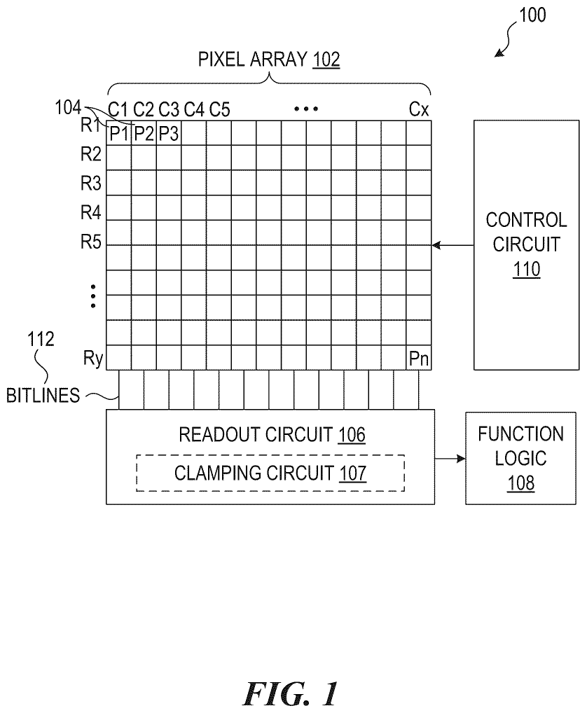

FIG. 1 is a partially schematic diagram of an imaging system 100 configured in accordance with various embodiments of the present technology. The imaging system 100 includes a pixel array 102, bitlines 112, a readout circuit 106, function logic 108, and a control circuit 110. In one example, the pixel array 102 is a two-dimensional (2D) array including a plurality of pixel circuits 104 (e.g., P1, P2, P3, . . . , Pn) that are arranged into rows (e.g., R1 to Ry) and columns (e.g., C1 to Cx) to acquire image data of a person, place, object, etc., which can then be used to render an image of a person, place, object, etc. In various examples, the pixel circuits 104 include photosensors (e.g., photodiodes) that are configured to provide image data.

In various examples, the readout circuit 106 may be configured to read out image data through the bitlines 112 (e.g., column bitlines). The readout circuit 106 may include an analog-to-digital converter (ADC) (not shown) and a clamping circuit 107 (also referred to herein as “the replica voltage reference generation circuit 107”) configured in accordance with the teachings of the present disclosure. In the example, digital image data values generated by the ADC in the readout circuit 106 may then be received by function logic 108. Function logic 108 may simply store the digital image data or even manipulate the digital image data by applying post image effects (e.g., crop, rotate, remove red eye, adjust brightness, adjust contrast, or otherwise). As also described in further detail herein, the clamping circuit 107 can provide an ASIC clamp voltage level at select ones of the bitlines 112.

In one example, the control circuit 110 is coupled to the pixel array 102 to control operation of the plurality of photosensors in the pixel array 102. For example, the control circuit 110 may generate one or more clamping voltage reference signals (each unique to a readout mode of the image system 100) for controlling the clamping circuit 107 and/or rolling clamping circuits (not shown). Additionally, or alternatively, the control circuit 110 may generate a shutter signal (e.g., a rolling shutter signal) for controlling image acquisition. In other examples, image acquisition is synchronized with lighting effects such as a flash.

In one example, the imaging system 100 may be included in a digital camera, cell phone, laptop computer, an endoscope, a security camera, or an imaging device for automobile, and/or the like. Additionally, the imaging system 100 may be coupled to other pieces of hardware such as a processor (general purpose or otherwise), memory elements, output (USB port, wireless transmitter, HDMI port, etc.), lighting/flash, electrical input (keyboard, touch display, track pad, mouse, microphone, etc.), and/or display. Other pieces of hardware may deliver instructions to the imaging system 100, extract image data from the imaging system 100, or manipulate image data supplied by the imaging system 100.

In some embodiments, the imaging system 100 can include a pixel die and an ASIC die (e.g., a logic die). The pixel array 102 can be included on the pixel die. Additionally, or alternatively, the readout circuit 106, function logic 108, and/or the control circuit 110 can be included on the ASIC die. Thus, in embodiments in which the readout circuit 106 is positioned on the ASIC die, the clamping circuit 107 can be referred to as an ASIC clamping circuit.

Furthermore, in some embodiments, the imaging system 100 can be or include a bitline-cut image sensor in which two or more bitlines 112 are coupled to pixel circuits 104 of a given column Cx of the pixel array 102. For example, an upper half of pixel circuits 104 in column C1 can be coupled to a first or “top” bitline 112, and a lower half of pixel circuits 104 in column C1 can be coupled to a second or “bottom” bitline. As described in further detail herein, the clamping circuit 107 can clamp pixel circuits 104 in rows near a bitline cut region (e.g., a boundary between the “top” and “bottom” bitlines), and remaining ones of the pixel circuits 104 can be clamped via, e.g., rolling clamping. Additional details regarding rolling clamping are provided in U.S. Pat. No. 11,843,884, titled “HV DRIVER FOR ROLLING CLAMP IN IMAGE SENSOR,” and filed on Apr. 28, 2023, the disclosure of which is incorporated by reference herein in its entirety.

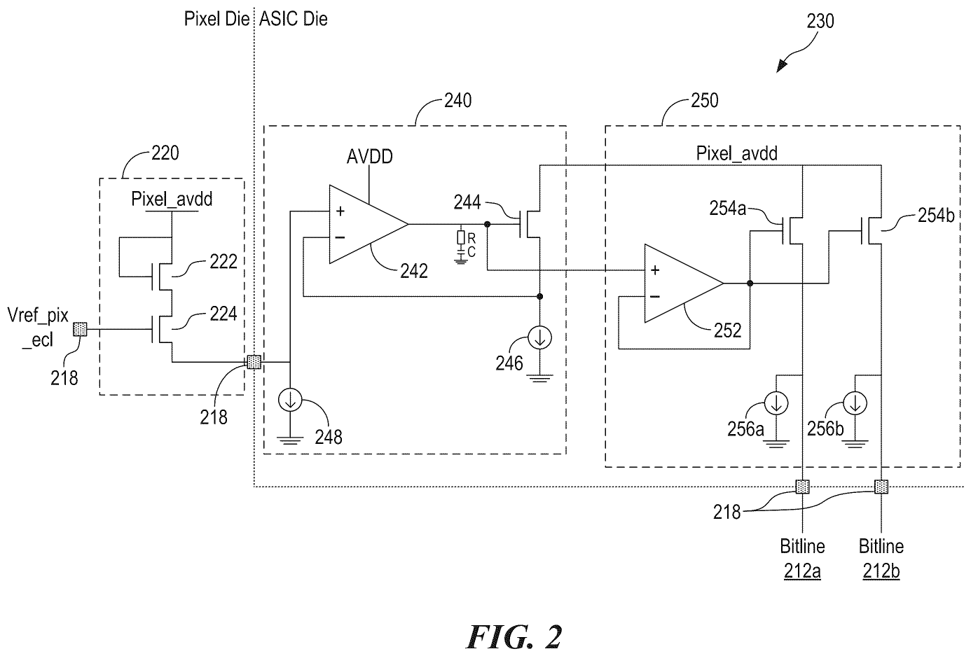

FIG. 2 is a partially schematic diagram of a clamping circuit 230 (also referred to herein as “the replica voltage reference generation circuit 230”) configured in accordance with various embodiments of the present technology. The clamping circuit 230 can be an example of the clamping circuit 107 of FIG. 1 (e.g., as part of the readout circuit 106) or of other clamping circuits configured in accordance with various embodiments of the present technology. As shown, the clamping circuit 230 is coupled to a pixel circuit 220. The pixel circuit 220 can be an example of one of the pixel circuits 104 of FIG. 1 or of other pixel circuits configured in accordance with various embodiments of the present technology. In the illustrated embodiment, the pixel circuit 220 is included on a pixel die, and the clamping circuit is included on an ASIC die. Thus, the clamping circuit 230 can also be referred to herein as an “ASIC clamping circuit.” Circuitry on the pixel die, circuitry on the ASIC die, and/or circuitry on other dies can be coupled to one another via interconnects 218 (e.g., hybrid bonds).

In the illustrated embodiment, the pixel circuit 220 includes a row select (RS) NMOS transistor 224 and a source follower (SF) NMOS transistor 222 coupled between a first supply voltage Pixel_avdd and the RS transistor 224. The gate of the SF transistor 222 can be coupled to the first supply voltage Pixel_avdd. For example, the SF transistor 222 can be a diode-connected transistor, having its gate coupled to its drain. The gate of the RS transistor 224 can be coupled to receive a bitline clamping reference signal Vref_pix_ecl generated by, for example, the control circuit 110 of FIG. 1. The bitline clamping reference signal Vref_pix_ecl can be a variable signal (e.g., having a variable voltage level) or a signal with a fixed value (e.g., having a predetermined, constant voltage level). In some embodiments, the pixel circuit 220 is a spare pixel circuit (e.g., of a spare row, such as a top-most row or in a bottom-most row of the pixel array, and/or not used for image signal generation).

The clamping circuit 230 can include a first (or input) stage 240 coupled to the pixel circuit 220 (and thus the associated pixel array) and a second (or output) stage 250 coupled between the input stage 240 and one or more bitlines (two bitlines labeled 212a and 212b in FIG. 2, collectively referred to as “the bitlines 212”). The input stage 240 can include a first op-amp 242 and a first NMOS transistor 244. The first op-amp 242 can include (i) a non-inverting input coupled to the RS transistor 224 (e.g., via the interconnect 218) and to ground via a first current source 248, (ii) an inverting input coupled to ground via a second current source 246, and (iii) an output. The first op-amp 242 can be coupled to receive power from a second supply voltage AVDD. The first transistor 244 can include (i) a gate coupled to the output of the first op-amp 242, (ii) a drain coupled to the first supply voltage Pixel_avdd, and (iii) a source coupled to the inverting input of the first op-amp 242 and to ground via the second current source 246.

The second supply voltage AVDD can be different from the first supply voltage Pixel_avdd (e.g., the first supply voltage Pixel_avdd can be about 2.7 V, and the second supply voltage AVDD can be about 3.3 V). In some embodiments, the first supply voltage Pixel_avdd is less noisy than the second supply voltage AVDD. For example, the second supply voltage AVDD can be a relatively noisy external supply voltage, and the first supply voltage Pixel_avdd can be the regulated output of a regulator (e.g., in a logic die) having the second supply voltage AVDD as its input.

In some embodiments, the input stage 240 also includes an RC series circuit coupled between (i) a node between the first op-amp 242 and the first transistor 244 and (ii) ground, as shown. The RC series circuit can provide stability compensation at the output of the first op-amp 242. The resistance of the resistor (R) of the RC series circuit can be set to avoid damping the capacitor (C) of the RC series circuit during frequency compensation (e.g., less than 400 ohms).

The output stage 250 can include a second op-amp 252 and one or more second NMOS transistors (two second transistors labeled 254a and 254b in FIG. 2, collectively referred to as “the second transistors 254”). The second op-amp 252 can include (i) a non-inverting input coupled to the output of the first op-amp 242, (ii) an inverting input, and (iii) an output coupled to the inverting input of the second op-amp 252. Thus, the second op-amp 252 can be configured as a voltage follower op-amp. Each of the second transistors 254 can include (i) a gate coupled to the output of the second op-amp 252, (ii) a drain coupled to the first supply voltage Pixel_avdd, and (iii) a source coupled to a corresponding one of the one or more bitlines 212 and to ground via a corresponding one of third current sources (two third current sources labeled 256a and 256b in FIG. 2, collectively referred to as “the third current source 256”).

The first, second, and third current sources 248, 246, 256 can each be configured to provide a suitable current. In some embodiments, the first current source 248 can be configured to supply a current that is 4 times greater than the current supplied by each of the second current source 246 and the third current sources 256. As a specific example, the first current source 248 can be configured to provide a current of about 16 μA, and each of the second current source 246 and the third current sources 256 can be configured to provide a current of about 4 μA.

The circuit components illustrated and described above are arranged such that (a) a voltage produced at a source of the RS transistor 224 generally follows a bitline clamping reference signal Vref_pix_ecl received at a gate of the RS transistor 224, (b) a voltage at the output of the first op-amp 242 generally follows the voltage produced at the source of the RS transistor 224, (c) a voltage at the output of the second op-amp 252 equal to the voltage at the output of the first op-amp 242, and (d) a voltage produced at the source of each of the one or more second transistors 254 generally follows the voltage at the output of the second op-amp 252. More specifically, as a bitline clamping reference signal Vref_pix_ecl is applied to the gate of the RS transistor 224, a corresponding voltage is (a) produced at the source of the RS transistor 224 and (b) input, via the interconnect 218, into the non-inverting input of the first op-amp 242 of the clamping circuit 230. The voltage produced at the source of the RS transistor 224 can be representative of a clamping voltage level used (e.g., during rolling clamping) for pixel circuits of the pixel array that are not clamped by the clamping circuit 230 (e.g., for pixel circuits that are not positioned near the bitline cut region). Thus, the voltage produced at the source of the RS transistor 224 can be referred to herein as a “rolling clamping level,” a “pixel die clamping level,” and/or the like.

As the voltage produced at the source of the RS transistor 224 is fed into the non-inverting input of the first op-amp 242, a corresponding voltage is output from the first op-amp 242 and input into the non-inverting input of the second op-amp 252 of the clamping circuit 230. A corresponding voltage is then output from the second op-amp 252 and applied to gates of the second transistors 254, thereby producing corresponding voltages at the sources of the second transistors 254 that are applied to the bitlines 212. In this manner, voltages produced on the bitlines 212 via the clamping circuit 230 on the ASIC die (i) are based at least in part on the bitline clamping reference signal Vref_pix_ecl applied to the gate of the RS transistor 224 on the pixel die and (ii) generally follow (e.g., are substantially equivalent to) voltages produced at the source of the RS transistor 224 (which, as discussed above, can be representative of rolling clamp voltage levels used for rolling clamping at the pixel die). Voltages output from the clamping circuit 230 and applied to the bitlines 212 are also referred to herein as “bitline clamping levels,” “bitline clamping voltages,” “ASIC bitline clamping levels,” “ASIC bitline clamping voltages,” and the like.

As shown in FIG. 2, the first transistor 244 of the input stage 240 of the clamping circuit 230 is part of a negative feedback loop for the first op-amp 242. Thus, in the event that there are threshold voltage differences between the first transistor 244 and the RS transistor 224 due to process differences and/or temperature drift, the negative feedback compensates for these differences. For example, as voltages produced at the source of the first transistor 244 change (e.g., due to changes in the threshold voltage of the first transistor 244 induced by temperature drift), the first op-amp 242 dynamically adjusts the output of the first op-amp 242 to oppose the change and adjust the voltage at the source of the first transistor 244 back toward the voltage fed into the non-inverting input of the first op-amp 242 from the source of the RS transistor 224. As a result, voltages that are produced at the source of the RS transistor 224 and fed into the non-inverting input of the first op-amp 242 are generally copied to the sources of the second transistors 254 via the clamping circuit 230 despite differences in threshold voltages. Therefore, the clamping circuit 230 of FIG. 2 is expected to compensate for threshold voltage process differences and/or temperature-induced threshold voltage changes, thereby achieving bitline clamping voltages at the bitlines 212 that are substantially equivalent to the voltages produced at the source of the RS transistor 224 (which, as discussed above, are representative of rolling clamp voltages used for rolling clamping at the pixel die). As such, the clamping circuit 230 is expected to reduce, minimize, or eliminate image quality issues (e.g., visible image banding) that can occur as a result of differences in clamping voltages produced by pixel circuits on a pixel die and ASIC clamping circuits on an ASIC die.

It will be appreciated that the op-amps and/or the transistors illustrated herein are merely example voltage follower components or combinations of components, and that the clamping circuit 230 can include alternative and/or additional voltage follower components in other embodiments. For example, the clamping circuit 230 can be coupled to multiple pixel circuits 220. Continuing with this example, the non-inverting input of the first op-amp 242 can be coupled to the sources of multiple RS transistors 224 that are each configured to receive the bitline clamping reference signal Vref_pix_ecl. Such an arrangement can help to even (or average) out the threshold voltage offsets of the RS transistors 224 such that voltages produced at the sources of the RS transistors 224 and that are fed into the first op-amp 242 are less sensitive to process differences and/or temperature-induced changes in threshold voltages of the RS transistors 224. Also, while FIG. 2 illustrates two second transistors 254, the output stage 250 can include a different number of second transistors 254 (and associated third current sources 256) depending on the number of bitlines 212 coupled to the clamping circuit 230. In some embodiments, individual ones of the first transistor 244 and the second transistors 254 can be implemented as low-threshold transistors (e.g., having a Vth of about 200 mV) and/or standard-threshold transistors (e.g., having a Vth of about 500 mV).

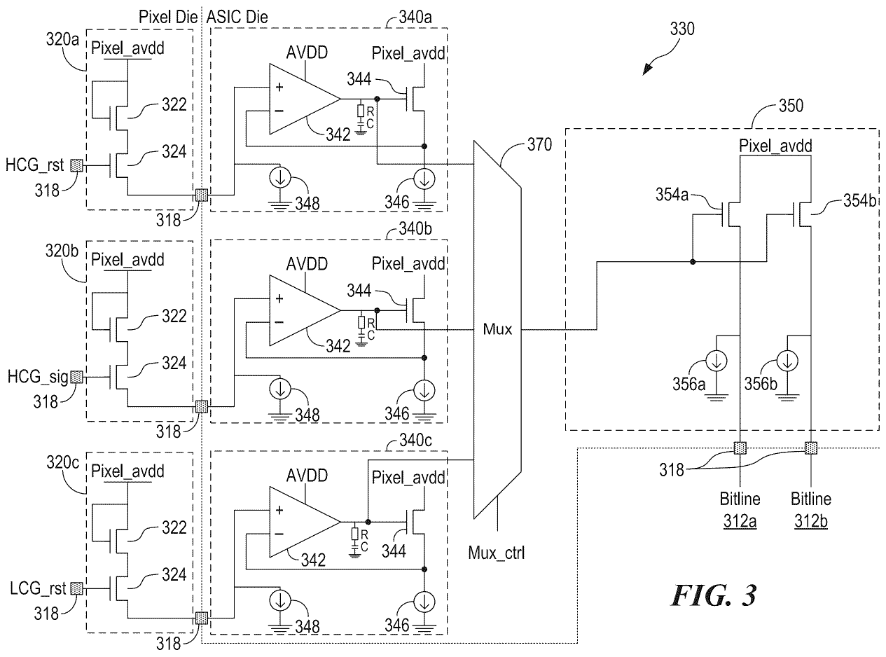

FIG. 3 is a partially schematic diagram of another clamping circuit 330 (also referred to herein as “the replica voltage reference generation circuit 330”) configured in accordance with various embodiments of the present technology. The clamping circuit 330 can be an example of the clamping circuit 107 of FIG. 1 (e.g., as part of the readout circuit 106), of the clamping circuit 230 of FIG. 2, or of other clamping circuits configured in accordance with various embodiments of the present technology. As shown, the clamping circuit 330 is coupled to a plurality of pixel circuits (three pixel circuits 320a, 320b, and 320c shown in FIG. 3, and collectively referred to as “the pixel circuits 320”). Each of the pixel circuits 320 can be an example of one of the pixel circuits 104 of FIG. 1, the pixel circuit 220 of FIG. 2, or of other pixel circuits configured in accordance with various embodiments of the present technology. Each of the pixel circuits 320 can be positioned on a pixel die, and the clamping circuit 330 can be included on an ASIC die. Thus, the clamping circuit 330 can also be referred to herein as an “ASIC clamping circuit.” Circuitry on the pixel die, circuitry on the ASIC die, and/or circuitry on other dies can be interconnected via interconnects 318 (e.g., hybrid bonds).

In the illustrated embodiment, each of the pixel circuits 320 includes a RS transistor 324 and a SF transistor 322 coupled between a first supply voltage Pixel_avdd and the RS transistor 324. The gate of each of the SF transistors 322 can be coupled to the first supply voltage Pixel_avdd. Thus, the SF transistors 322 can be configured as diode-connected transistors, having their gates tied to their drains. The gate of each the RS transistors 324 can be coupled to receive a corresponding (or unique) bitline clamping reference signal generated by, for example, the control circuit 110 of FIG. 1. In the illustrated embodiment, for example, the gate of the RS transistor 324 included in the first pixel circuit 320a is coupled to receive a bitline clamping reference signal HCG_rst associated with a high conversion gain readout mode (e.g., readout of a high conversion gain reset signal) of the corresponding image sensor, the gate of the RS transistor 324 included in the second pixel circuit 320b is coupled to receive a bitline clamping reference signal HCG_sig associated with a high conversion gain readout mode (e.g., readout of a high conversion gain signal) of the corresponding image sensor, and the gate of the RS transistor 324 included in the third pixel circuit 320c is coupled to receive a bitline clamping reference signal associated with a low conversion gain readout mode (e.g., readout of a low conversion gain reset signal) of the corresponding image sensor. In some embodiments, the pixel circuits 320 are spare pixel circuits (e.g., of one or more spare rows, such as a top-most row or in a bottom-most row of the pixel array, and/or not used for image signal generation).

As shown, the clamping circuit 330 can include a plurality of first (or input) stages 340 (three input stages 340a, 340b, and 340c shown in FIG. 3), each coupled to a corresponding one of the pixel circuits 320 (and thus the associated pixel array). The clamping circuit 330 can further include a multiplexer 370 having a plurality of inputs, each coupled to a corresponding one of the input stages 340. In addition, the clamping circuit 330 can include a second (or output) stage 350 coupled between an output of the multiplexer 370 and one or more bitlines (two bitlines labeled 312a and 312b in FIG. 3, collectively referred to as “the bitlines 312”). Each of the input stages 340 can include an op-amp 342 and a first NMOS transistor 344. The op-amp 342 of each input stage 340 can include (i) a non-inverting input coupled to the source of the RS transistor 324 of the corresponding pixel circuit 320 and to ground via a first current source 348, (ii) an inverting input coupled to ground via a second current source 346, and (iii) an output. The op-amp 342 can be coupled to receive power from a second supply voltage AVDD. The first transistor 344 can include (i) a gate coupled to the output of the op-amp 342, (ii) a drain coupled to the first supply voltage Pixel_avdd, and (iii) a source coupled to the inverting input of the op-amp 342 and to ground via the second current source 348. The second supply voltage AVDD can be (or be equivalent to) the first supply voltage Pixel_avdd, or the second supply voltage AVDD can be different from the first supply voltage Pixel_avdd (as discussed in further detail above with reference to FIG. 2).

In some embodiments, each of the input stages 340 also includes an RC series circuit coupled between (i) a node between the op-amp 342 and the first transistor 344 and (ii) ground, as shown. The RC series circuit can provide stability compensation at the output of the op-amp 342. The resistance of the resistor (R) of the RC series circuit can be set to avoid damping the capacitor (C) of the RC series circuit during frequency compensation (e.g., less than 400 ohms).

The multiplexer 370 can include a plurality of inputs, each coupled to the output of one of the op-amps 342, and an output coupled to the output stage 350. The multiplexer 370 can select one of its inputs as its output in response to a multiplexer control signal Mux_ctrl. Thus, the multiplexer 370 can selectively couple each of the input stages 340 to the output stage 350.

The output stage 350 can include one or more second transistors (two second transistors labeled 354a and 354b in FIG. 3, collectively referred to as “the second transistors 354”). Each of the second transistors 354 can include (i) a gate coupled to the output of the multiplexer 370, (ii) a drain coupled to the first supply voltage Pixel_avdd, and (iii) a source coupled to a corresponding one of the one or more bitlines 312 and to ground via a corresponding one of third current sources (two third current sources labeled 356a and 356b in FIG. 3, collectively referred to as “the third current source 356”).

The first, second, and third current sources 348, 346, 356 can each be configured to provide a suitable current. In some embodiments, each of the first current sources 348, the second current sources 346, and the third current sources 356 can be configured to supply the same current. As a specific example, each of the first current sources 348, the second current sources 346, and the third current sources 356 can be configured to provide a current of about 4 μA.

In the illustrated embodiment, three sets of circuit components are shown: (1) a first set including the pixel circuit 320a, the input stage 340a, and the second stage 350; (2) a second set including the pixel circuit 320b, the input stage 340b, and the second stage 350; and (3) a third set including the pixel circuit 320c, the input stage 340c, and the second stage 350. In operation, each of the sets are configured to operate in a generally similar manner as the pixel circuit 220 and the clamping circuit 230 illustrated in FIG. 2 and described in detail above, at least when the output of the input stage 340 of a given set is coupled to the second stage 350 via the multiplexer 370. For example, the first set can be operated in a generally similar manner as the pixel circuit 220 and the clamping circuit 230 illustrated in FIG. 2 (e.g., to produce a bitline clamping voltage at the sources of the second transistors 354 that is substantially the same as the voltage produced at the source of the RS transistor 324 of the pixel circuit 320a) at least when the output of the input stage 340a is coupled to the input of the second stage 350 via the multiplexer 370; the second set can be operated in a generally similar manner as the pixel circuit 220 and the clamping circuit 230 illustrated in FIG. 2 (e.g., to produce a bitline clamping voltage at the sources of the second transistors 354 that is substantially the same as the voltage produced at the source of the RS transistor 324 of the pixel circuit 320b) at least when the output of the input stage 340b is coupled to the input of the second stage 350 via the multiplexer 370; and the third set can be operated in a generally similar manner as the pixel circuit 220 and the clamping circuit 230 illustrated in FIG. 2 (e.g., to produce a bitline clamping voltage at the sources of the second transistors 354 that is substantially the same as the voltage produced at the source of the RS transistor 324 of the pixel circuit 320c) at least when the output of the input stage 340c is coupled to the input of the second stage 350 via the multiplexer 370. Thus, operation of each of the first, second, and third sets is largely omitted here for the sake of brevity in light of the detailed discussion provided above with reference to FIG. 2.

In the embodiment illustrated in FIG. 3, each of the bitline clamping reference signals HCG_rst, HCG_sig, LCG_rst can differ from one another and/or correspond to different readout modes of the corresponding image sensor. Thus, corresponding voltages produced at the sources of the corresponding RS transistors 324 (and therefore at the sources of the second transistors 354 when coupled via the multiplexer 370) can differ from one another. As a result, the multiplexer 370 can be controlled (via the multiplexer control signal Mux_ctrl) such that bitline clamping voltages produced at the sources of the second transistors 354 and applied to the bitlines 312 correspond to readout modes of the image sensor. In other words, the clamping circuit 330 enables producing a unique bitline clamping voltage on the bitlines 312 for different readout modes of the image sensor. As a result, the clamping circuit 330 can be less sensitive to temperature-induced threshold voltage changes in the RS transistor 324 of the pixel circuits 320.

As discussed above with reference to FIG. 2, notwithstanding any processing differences or temperature variations between components included in the pixel die and components included in the ASIC die, the clamping circuit 330 enables use of substantially the same clamping voltage level for all pixel circuits included in a pixel array, whether clamped via rolling clamping or by the clamping circuit 330, and whether positioned proximate a bitline cut region or not. As discussed above, applying a uniform clamp voltage across a pixel array can result in higher image quality (e.g., no or reduced visible image banding) compared to other bitline-cut image sensors that utilize different clamping voltage levels for pixels proximate the bitline cut region (e.g., due to process differences and/or temperature drift).

It will be appreciated that the op-amps and/or the transistors illustrated herein are merely example voltage follower components or combinations of components, and that the clamping circuit 330 can include alternative and/or additional voltage follower components. Also, the multiplexer 370 can be replaced with a set of switches or other selection circuit components. In some embodiments, each input stage 340 can be coupled to multiple pixel circuits 320, and thus the non-inverting input of each op-amp 342 can be coupled to the sources of multiple RS transistors 324 that are each configured to receive a same bitline clamping reference signal. Such an arrangement can help to even (or average) out the threshold voltage offsets of the RS transistors 324 such that voltages produced at the sources of the RS transistors 324 and that are fed into the op-amp 342 are less sensitive to process differences and/or temperature-induced changes in threshold voltages of the RS transistors 324. While FIG. 3 illustrates the clamping circuit 330 as including three input stages 340 that are each coupled to a corresponding one of three pixels circuits 320, a different number of input stages 340 (e.g., two, four, five, or more) and/or a different number of pixel circuits (e.g., two, four, five, or more) can be included. As a specific example, the clamping circuit 330 can include one or more additional input stages 340 that are each coupled to a corresponding one of one or more additional pixel circuits 320, each having a RS transistor 324 that includes a gate configured to receive a bitline clamping reference signal corresponding to another corresponding readout mode (e.g., LCG signal, lateral overflow integration capacitor (LOFIC) reset, LOFIC signal, and/or the like) of the image sensor. Additionally, or alternatively, one or more other bitline clamping reference signals corresponding to one or more other readout modes (e.g., LCG signal, lateral overflow integration capacitor (LOFIC) reset, LOFIC signal, and/or the like) of the image sensor can be used in addition to or in lieu of one or more of the bitline clamping reference signals HCG_rst, HCG_sig, and/or LCG_rst shown in FIG. 3. Also, while FIG. 3 illustrates two second transistors 354, the output stage 350 can include a different number of second transistors 354 (and associated third current sources 356) depending on the number of bitlines 312 coupled to the clamping circuit 330. In some embodiments, individual ones of the first transistor 344 and the second transistors 354 can be implemented as low-threshold transistors (e.g., having a Vth of about 200 mV) and/or standard-threshold transistors (e.g., having a Vth of about 500 mV).

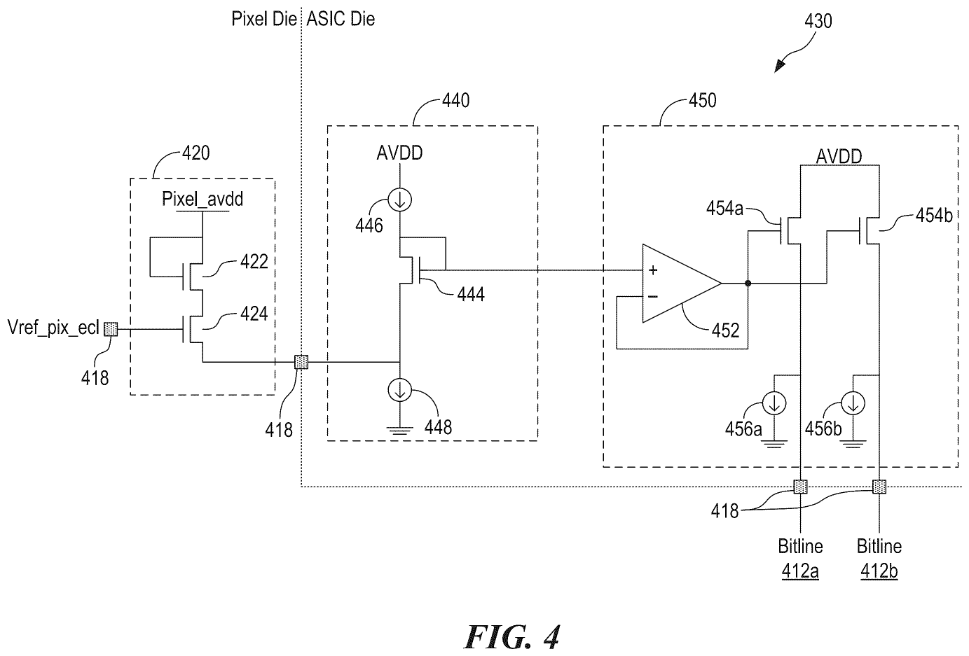

FIG. 4 is a partially schematic diagram of still another clamping circuit 430 (also referred to herein as “the replica voltage reference generation circuit 430”) configured in accordance with various embodiments of the present technology. The clamping circuit 430 can be an example of the clamping circuit 107 of FIG. 1 (e.g., as part of the readout circuit 106), or of other clamping circuits configured in accordance with various embodiments of the present technology. As shown, the clamping circuit 430 is coupled to a pixel circuit 420. The pixel circuit 420 can be an example of one of the pixel circuits 104 of FIG. 1, of the pixel circuit 220 of FIG. 2, of one of the pixel circuits 320 of FIG. 3, or of other pixel circuits configured in accordance with various embodiments of the present technology. The pixel circuit 420 can be included on a pixel die, and the clamping circuit 430 can be included on an ASIC die. Thus, the clamping circuit 430 can also be referred to herein as an “ASIC clamping circuit.” Circuitry on the pixel die, circuitry on the ASIC die, and/or circuitry on other dies can be interconnected via interconnects 418 (e.g., hybrid bonds).

In the illustrated embodiment, the pixel circuit 420 includes a RS NMOS transistor 424 and a SF NMOS transistor 422 coupled between a first supply voltage Pixel_avdd and the RS transistor 424. The gate of the SF transistor 422 can be coupled to the first supply voltage Pixel_avdd. Thus, the SF transistor 422 can be a diode-connected transistor, having its gate tied to its drain. The gate of the RS transistor 424 can be coupled to receive a bitline clamping reference signal Vref_pix_ecl generated by, for example, the control circuit 110 of FIG. 1. In some embodiments, the pixel circuit 420 is a spare pixel circuit (e.g., of a spare row, such as a top-most row or in a bottom-most row of the pixel array, and/or not used for image signal generation).

As shown, the clamping circuit 430 can include a first (or input) stage 440 coupled to the pixel circuit 420 (and thus the associated pixel array) and a second (or output) stage 450 coupled between the input stage 440 and one or more bitlines (two bitlines labeled 412a and 412b in FIG. 4, collectively referred to as “the bitlines 412”). The input stage 440 can include a first NMOS transistor 444 having (i) a drain coupled to a second supply voltage AVDD via a first current source 446, (ii) a source coupled to the RS transistor 424 and to ground via a second current source 448, and (iii) a gate coupled to the drain of the first transistor 444. Thus, the first transistor 444 can be a diode-connected transistor. The second supply voltage AVDD can be (or be equivalent to) the first supply voltage Pixel_avdd, or the second supply voltage AVDD can be different from the first supply voltage Pixel_avdd.

The output stage 450 can include an op-amp 452 and one or more second transistors (two second transistors labeled 454a and 454b in FIG. 4, collectively referred to as “the second transistors 454”). The op-amp 452 can include (i) a non-inverting input coupled to the gate of the first transistor 444, (ii) an inverting input, and (iii) an output coupled to the inverting input of the op-amp 452. Thus, the op-amp 452 can be configured as a voltage follower op-amp, and may boost the driving capability of the clamping circuit 430 to drive multiple transistors (e.g., thousands of transistors) for all bitlines. Each of the second transistors 454 can include (i) a gate coupled to the output of the op-amp 452, (ii) a drain coupled to the second supply voltage AVDD, and (iii) a source coupled to a corresponding one of the one or more bitlines 412 and to ground via a corresponding one of third current sources (two third current sources labeled 456a and 456b in FIG. 4, collectively referred to as “the third current source 456”). In some embodiments, the output stage 450 omits the op-amp 452, and the gates of the second transistors 454 can be (e.g., directly) coupled to the gate of the first transistor 444 instead.

The first, second, and third current sources 446, 448, 456 can each be configured to provide a suitable current. In some embodiments, each of the first current source 446 and the third current sources 456 can be configured to supply a current that is half the current supplied by the second current source 448. As a specific example, each of the first current source 446 and the third current sources 456 can be configured to provide a current of about 4 μA, and the second current source 448 can be configured to provide a current of about 8 μA.

The first current source 446 and the second current source 448 establish a current relation. More specifically, continuing with the above example in which the first current source 446 provides a current that is half the current provided by the second current source 448, the current relation is I/2:I. As a result, the source of the RS transistor 424 and the source of the first transistor 444 have a same source current of I/2. Therefore, because the first transistor 444 is diode-connected, a voltage at the gate of the first transistor 444 will generally follow the voltage produced at the source of the RS transistor 424 as a result of the bitline clamping reference signal applied to the gate of the RS transistor 424 and despite threshold voltage differences due to process differences and/or temperature drift. In turn, assuming (a) that the first transistor 444, the second transistor 454a, and the second transistor 454b are each the same size and (b) that the third current sources 456 each provide a same amount of current as the second current source 446 such that the first transistor 444, the second transistor 454a, and the second transistor 454b each have the same drain-to-source current I_{ds}, the gate-to-source voltage V_{GS} of each of the first transistor 444, the second transistor 454a, and the second transistor 454b are each forced to be the same. In other words, the voltages produced at the sources of the second transistor 454 generally follow and are substantially the same as the voltage produced at the source of the RS transistor 424. In this manner, voltages produced on the bitlines 412 via the clamping circuit 430 on the ASIC die (i) are based at least in part on the bitline clamping reference signal Vref_pix_ecl applied to the gate of the RS transistor 424 on the pixel die and (ii) generally follow (e.g., are substantially equivalent to) voltages produced at the source of the RS transistor 424.

As discussed above, the voltage produced at the source of the RS transistor 424 can be representative of a clamping voltage level used (e.g., during rolling clamping) for pixel circuits of the pixel array that are not clamped by the clamping circuit 430 (e.g., for pixel circuits that are not positioned near the bitline cut region). Thus, the voltage produced at the source of the RS transistor 424 can be referred to herein as a “rolling clamping level,” a “pixel die clamping level,” and the like. Voltages output from the clamping circuit 430 and applied to the bitlines 412 are also referred to herein as “bitline clamping levels,” “bitline clamping voltages,” “ASIC bitline clamping levels,” “ASIC bitline clamping voltages,” and the like. As such, voltages produced on the bitlines 412 via the clamping circuit 430 on the ASIC die are substantially the same as voltages produced at the source of the RS transistor 424 (which, as discussed above, can be representative of rolling clamp voltage levels used for rolling clamping at the pixel die). Applying a uniform clamp voltage across a pixel array can result in higher image quality (e.g., no or reduced visible image banding) compared to, for example, other bitline-cut image sensors that may utilize ASIC bitline clamping voltages that differ from bitline clamping voltages used at the pixel die.

Compared to the clamping circuits 230 and 330 of FIGS. 2 and 3, respectively, which include dynamic feedback loops (and associated closed-loop frequency responses), the clamping circuit 430 includes fewer or no negative feedback op-amps (and associated loop responses) and/or includes an open loop to generate a dynamic signal at the gate of the first transistor 444 that tracks the voltage produced at the source of the RS transistor 424. As a result, it is expected that the clamping circuit 430 may be able to provide faster operations (e.g., as long as appropriate, precise current sources are included) in comparison to the clamping circuits 230 and 330.

It will be appreciated that the op-amp and/or the transistors illustrated herein are merely example voltage follower components or combinations of components, and that the clamping circuit 430 can include alternative and/or additional voltage follower components in other embodiments. For example, the clamping circuit 430 can be coupled to multiple pixel circuits 420. Continuing with this example, the source of the first transistor 444 can be coupled to the sources of multiple RS transistors 424 that are each configured to receive the bitline clamping reference signal Vref_pix_ecl. Such an arrangement can help to even (or average) out the threshold voltage offsets of the RS transistors 424. Also, while FIG. 4 illustrates two second transistors 454, the output stage 450 can include a different number of second transistors 454 (and associated third current sources 456) depending on the number of bitlines 412 coupled to the clamping circuit 430. Furthermore, in some embodiments, the clamping circuit 430 can include multiple input stages 440, each coupled to a corresponding one of a plurality of pixel circuits 420, similar to the embodiment illustrated in FIG. 3. In some such embodiments, each pixel circuit 420 can be configured to produce a unique bitline clamping voltage (e.g., corresponding to a respective readout mode of the image sensor) based at least in part on a unique bitline clamping reference signal. In addition, the clamping circuit 430 can include a multiplexer configured to selectively couple one of the input stages 440 to the output stage 450 based at least in part on a multiplexer control signal. In some embodiments, individual ones of the first transistor 444 and the second transistors 454 can be implemented as low-threshold transistors (e.g., having a Vth of about 200 mV) and/or standard-threshold transistors (e.g., having a Vth of about 500 mV).

Referring to FIGS. 2-4, it is appreciated that the illustrated clamping circuits 230, 330, 430 are merely example implementations of the present technology. Clamping circuits (or replica voltage reference generation circuits) configured in accordance with embodiments of the present technology can have an input coupled to one or more pixel circuits (e.g., to one or more row select transistors thereof), and can be configured to receive a voltage at the input and generate a clamp voltage that follows the voltage received at the input for each of one or more bitlines coupled to one or more outputs of the replica voltage reference generation circuit.

### C. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An imaging system, comprising:
a pixel array including a plurality of pixel circuits, wherein select ones of the pixel circuits each includes:
a row select transistor, and
a source follower transistor coupled between a supply voltage and the row select transistor; and
a replica voltage reference generation circuit having an input coupled to the row select transistor, wherein the replica voltage reference generation circuit is configured to receive a voltage at the input and generate a clamp voltage that follows the voltage received at the input for each of one or more bitlines coupled to one or more outputs of the replica voltage reference generation circuit.

2. The imaging system of claim 1, wherein the pixel array is disposed on a pixel die, and wherein the replica voltage reference generation circuit is disposed on an application-specific integrated circuit (ASIC) die.

3. The imaging system of claim 1, wherein the replica voltage reference generation circuit includes:
an input stage coupled to the pixel array, wherein the input stage includes:
an op-amp having a non-inverting input coupled to the row select transistor, an inverting input, and an output, and
a first transistor having a gate coupled to the output of the op-amp, a drain coupled to the supply voltage, and a source coupled to the inverting input of the op-amp; and
an output stage coupled between the input stage and the one or more bitlines, wherein the output stage includes:
one or more second transistors, each having a gate coupled to the output of the op-amp, a drain coupled to the supply voltage, and a source coupled to a corresponding one of the one or more bitlines.

4. The imaging system of claim 3, wherein the op-amp is a first op-amp, wherein the output stage further includes a second op-amp having a non-inverting input coupled to the output of the first op-amp, an inverting input, and an output coupled to the inverting input of the second op-amp, and wherein the gate of each of the one or more second transistors is coupled to the output of the second op-amp.

5. The imaging system of claim 4, wherein:
a voltage at a source of the row select transistor is configured to follow a clamp voltage received at a gate of the row select transistor;
a voltage at the output of the first op-amp is configured to follow the voltage at the source of the row select transistor;
a voltage at the output of the second op-amp is configured to follow the voltage at the output of the first op-amp; and
a voltage at the source of each of the one or more second transistors is configured to follow the voltage at the output of the second op-amp.

6. The imaging system of claim 3, wherein the replica voltage reference generation circuit further comprises:
a plurality of input stages including the input stage; and
a multiplexer selectively coupling each of the plurality of input stages to the output stage,
wherein the multiplexer includes a plurality of inputs, each coupled to a respective output of one of the plurality of input stages, and
wherein the multiplexer further includes an output coupled to the output stage.

7. The imaging system of claim 6, wherein each respective output of the plurality of input stages is configured to follow a unique clamp voltage of a plurality of unique clamp voltages, wherein the multiplexer further includes a select input coupled to receive a timing control signal, and wherein the output of the multiplexer is configured to follow one of the plurality of unique clamp voltages in response to the timing control signal.

8. The imaging system of claim 7, wherein at least one unique clamp voltage of the plurality of unique clamp voltages corresponds to a high conversion gain (HCG) reset, an HCG signal, a low conversion gain (LCG) reset, an LCG signal, a lateral overflow integration capacitor (LOFIC) reset, and/or a LOFIC signal.

9. The imaging system of claim 3, wherein the input stage further includes:
a first current source coupled between the non-inverting input of the op-amp and ground; and
a second current source coupled between the source of the first transistor and ground.

10. The imaging system of claim 3, wherein the output stage further includes one or more current sources, each coupled between the source of a corresponding one of the one or more second transistors and ground.

11. The imaging system of claim 3, wherein the non-inverting input of the op-amp is coupled to multiple row select transistors.

12. The imaging system of claim 3, wherein the op-amp is coupled to receive power from a second supply voltage different from the supply voltage.

13. The imaging system of claim 1, wherein the select ones of the pixel circuits are included in one or more spare rows of the pixel array.

14. A clamping circuit, comprising:
a first stage including:
an op-amp having a non-inverting input, an inverting input, and an output, wherein the output of the op-amp is configured to follow a voltage on the non-inverting input, and
a first transistor having a gate coupled to the output of the op-amp, a drain coupled to a supply voltage, and a source coupled to the inverting input of the op-amp; and
a second stage coupled between the input stage and one or more bitlines, wherein the second stage includes:
one or more second transistors, each having a gate coupled to the output of the op-amp, a drain coupled to the supply voltage, and a source coupled to a corresponding one of the one or more bitlines, wherein the source of each of the one or more second transistors is configured to follow a voltage at the gate of each of the one or more second transistors.

15. The clamping circuit of claim 14, further comprising:
a plurality of first stages including the input stage; and
a multiplexer coupled to the plurality of first stages and the second stage,
wherein the multiplexer includes a plurality of inputs, each coupled to a respective output of one of the plurality of first stages, and
wherein the multiplexer further includes an output coupled to the second stage.

16. An imaging system, comprising:
a pixel array including a plurality of pixel circuits, wherein select ones of the pixel circuits include:
a row select transistor, and
a source follower transistor coupled between a first supply voltage and the row select transistor; and
a clamping circuit including:
an input stage coupled to the pixel array, wherein the input stage includes a first transistor having a drain coupled to a second supply voltage, a source coupled to the row select transistor, and a gate coupled to the drain of the first transistor, and
an output stage coupled between the input stage and one or more bitlines, wherein the output stage includes one or more second transistors, each having a gate coupled to the gate of the first transistor, a drain coupled to the second supply voltage, and a source coupled to a corresponding one of the one or more bitlines.

17. The imaging system of claim 16, wherein the output stage further includes an op-amp having a non-inverting input coupled to the gate of the first transistor, an inverting input, and an output coupled to the inverting input of the op-amp, and wherein the gates of the one or more second transistors are each coupled to the output of the op-amp.

18. The imaging system of claim 16, wherein the input stage further includes:
a first current source coupled between the second supply voltage and the drain of the first transistor; and
a second current source coupled between the source of the first transistor and ground.

19. The imaging system of claim 18, wherein the first current source is configured to supply a first current, and wherein the second current source is configured to supply a second current that is twice the first current.

20. The imaging system of claim 16, wherein the output stage further includes one or more current sources each coupled between the source of a corresponding one of the one or more second transistors and ground.

21. The imaging system of claim 16, wherein:
a voltage at a source of the row select transistor is configured to follow a clamp voltage received at a gate of the row select transistor;
a voltage at the gate of the first transistor is configured to follow the voltage at the source of the row select transistor; and
a voltage the source of each of the one or more second transistors is configured to follow the voltage at the gate of the first transistor.

22. The imaging system of claim 16, wherein the second supply voltage is equivalent to the first supply voltage.

23. The imaging system of claim 16, wherein the pixel array is disposed on a first die, and wherein the clamping circuit is disposed on a second die different from the first die.
